(19) United States
(12) Patent Application Publication
(10) Pub. No.: US 2014/0238928 A1
(43) Pub. Date: Aug. 28, 2014

(54) FILTER MATERIAL

(71) Applicants: Edwin Koch, Tholey (DE); Matthias Schwender, Kirkel (DE); Andreas Schmitz, Kirkel (DE); Stefan Jochum, Huttigweiler (DE)

(72) Inventors: Edwin Koch, Tholey (DE); Matthias Schwender, Kirkel (DE); Andreas Schmitz, Kirkel (DE); Stefan Jochum, Huttigweiler (DE)

(21) Appl. No.: 13/261,833

(22) PCT Filed: Aug. 28, 2012
(86) PCT No.: PCT/EP2012/003604

§ 371 Date: Apr. 28, 2014

(30) Foreign Application Priority Data
Sep. 22, 2011 (DE) 10 2011 114 400.9

(51) Int. Cl. B01D 39/08

(52) U.S. Cl. CPC B01D 39/086
USPC 210/488; 210/505

(57) ABSTRACT

1. Filter material (1) and filter clement (29) with filter material (1). 2. The invention relates to a filter material (1), in particular for hydraulic filters, such as oil filters, consisting of at least one individual layer (5) of a composite of glass fibres (7) with carbon fibres (9). The invention timber relates to a filter element with a corresponding filter material (1).

The invention relates to a filter material, in particular for hydraulic filters, such as oil filters, comprising at least one individual layer of a composite of glass fibers with carbon fibers. In addition, the invention relates to a filter element having such a filter material.

Filter materials are used in a plurality of embodiments for the removal of dust particles from a gas stream that is laden with dust particles or also for the removal of other solid particles from streams of liquid media. The particulate contamination to be removed disrupts industrial processes and accelerates the wear of machinery and equipment. Moreover said contamination can also impact health and well-being.

Such filter materials are used in differently designed filter elements in order to form what is, in most cases, a multi-layered filter medium. The filter materials of this kind not only have the function of removing particles in flowable media, but also have the function of discharging, in particular, electrical potentials from the media. It has been shown that when there is a flow through the filter material of a filter potential differences and therefore electrostatic charges may arise. This may lead to increased oil aging in hydraulic oils, for example. Unwanted discharges can also result in damage to the filter material. In order to counteract this, the size of the charge that occurs and the build-up of potential between the filter material and the medium can be specifically influenced by a suitable design of the filter and a suitable selection of materials.

DE 102 008 004 344 A1 proposes various design measures in order to avoid the occurrence of damaging potential differences and charges during the operation of a filter element. Proposed as a design measure is the use of a filter medium in a filter for cleaning a flowable medium, the potential difference of said filter medium being low in comparison to that of the medium being cleaned. It is hereby ensured that no large electrostatic charge is generated. A further design measure proposed in the document is to design parts of the filter medium in such a way that these parts have potentials that differ from one another and/or from the fluid being cleaned such that these potentials at least partially cancel one another out. A further design measure for avoiding damaging potential differences in a filter according to the document is that at least partially conductive materials be used for the targeted discharge of electrical charges in the filter along a predeterminable path.

A filter solution of this kind removes electrical charges more slowly than a conductive filter, whereby such a medium is not highly charged during the operation of the filter. No field strength builds up in the filter that could lead to a discharge with a damaging effect on the filter and the medium. A further design measure to avoid damaging potential differences from occurring during the operation of a filter element is disclosed in the document such that a charge balancing layer is used downstream from the filter medium. This charge balancing layer, which may also be formed by a coating on the filter medium, reduces the charging of the medium and of the filter medium, and thus prevents discharges in the filter.

WO 03/033100 A1 describes a filter element for fluids, in particular for hydraulic fluids, having a filter material and having a grid shaped support structure supporting the filter material at least on the clean side in relation to the direction of flow through the filter element, wherein the support structure is made out of a plastic material and has electrically conductive elements for discharging electrical potentials from the fluid being filtered. The electrically conductive elements in the support structure are made out of metal threads, which are especially preferably formed from stainless steel, depending upon the chemical properties of the fluid that is to be filtered.

The document U.S. Pat. No. 5,527,569 describes an electrically conductive filter material comprising a porous membrane structure made out of polytetrafluoroethylene. The membrane structure contains electrically conductive particles. The electrically conductive particles are capable of effecting an electrical discharge route for discharging electrostatic charges in the filter material. The electrically conductive particles may be formed out of a metal or out of carbon, for example.

The document U.S. Pat. No. 4,606,968 describes a textile composite-filter material in the form of a fabric having warp and weft, into which electrically conductive threads are woven. The electrically conductive threads may be formed out of carbon fiber, for example.

The known filter materials, which are capable of preventing electrostatic charges in the respective medium to be filtered, or that are capable of discharging electrostatic charges from the medium, could be improved in terms of the underlying manufacturing processes and manufacturing costs associated therewith.

Starting from this prior art, the object of the invention is to provide a filter material, in particular for hydraulic filters, such as oil filters, which is inexpensive to manufacture, the filter fineness and electrical conductivity thereof can be defined in as simple a manner as possible, and which has a long service life. The object of the invention is also to create a filter element made of such a filter material.

These objects are achieved with a filter material having the features of claim 1 in its entirety, and with a filter element according to a coordinate claim.

The filter material according to the invention comprises at least one individual layer of a composite of glass fibers with carbon fibers. The exclusive use of fibers—glass fibers, carbon fibers—for the manufacture of at least one individual layer of the filter material makes it possible to use the same processing tools and process steps for both types of fibers, in contrast to the known filter materials, in which either the relevant base material for the respective filter material is present in different designs, or the relevant base materials have different physical characteristics (metallic threads, textile thread). In addition, glass fibers and carbon fibers behave in an inert manner with respect to many fluids.

Glass fibers and carbon fibers can be connected to one another by means of a “chaotic fleece or matrix arrangement” in an especially simple manner hereby. Thus the filter material is inexpensive to manufacture, and the filter fineness of said filter material and the electrical conductivity thereof can be easily defined.

Surprisingly, it has been shown that in order to effectively discharge electrostatic charges from the medium to be filtered, the percentage of carbon fibers in the composite can be lower than the percentage of glass fibers. It is also readily possible to effectively discharge electrostatic charges with a percentage of carbon fiber in the composite of only approximately 10%. In an especially preferred, cost-effective embodiment of the filter material, the glass fibers may be formed out of a mineral glass, such as borosilicate glass (70 to 80% SiO; 7 to 13% B₂O₂; 4 to 8% Na₂O, K₂O; 2 to 7% Al₂O₃). The glass fibers and/or carbon fibers may be disposed in the composite such that they are arranged chaotically or structured, in the form of a matrix or a fleece. The filter material can thus preferably be formed as a spun fleece, i.e. as a so-called spunbond, in which the spun fleece is created by means of a tangled deposit of melt-spun filaments on a matrix-like base structure. The filaments, in turn, are preferably formed out of continuous synthetic fibers made out of polymer materials than can be melt spun. Polyethylene, polyamide or polypropylene are especially suitable base structure for the production of such a filter material.

The composite of glass fibers and carbon fibers may also be, or is at least partially, formed by additives, in the form of binders such as acrylic resin, epoxy resin or a polymerized elastomer, in particular when the glass fibers and carbon fibers are configured such that they are positioned chaotically relative to one another as a fleece or mat. Here, the binder can connect the contact points of the fibers with one another, wherein the binder does not negatively impact the desired open pore volume of the filter material. The respective binder is selected, in particular, taking into account the chemical substance properties of the fluid that is to be filtered, which on the one hand should not dissolve the contact points created by the binder, and on the other hand, the binder should not have a negative chemical impact on the fluid.

For multifaceted uses in hydraulics and pneumatics, it has proven to be especially advantageous that the filter material be formed out of 70% to 90%, preferably approximately 80% borosilicate glass fibers, out of 3% to 20%, preferably approximately 5% plastic thermal bonding fibers, out of 3% to 20%, preferably approximately 5% additives (Binder) and out of approximately 5% to 30%, preferably approximately 10% carbon fibers. In a filter, the filter material according to the invention may preferably be used in planar contact with at least one additional functional layer, for example a support layer or a prefilter layer. The filter material according to the invention is suitable for use in filter elements having many different forms. In such a filter element, the filter material according to the invention may be applied in a sequence of individual layers as follows:
support grid
fleece material
large-pore fiber material
fine-pore fiber material
fleece material
support grid.

It is understood that any other sequence of individual layers, in particular the arrangement of the filter material according to the invention at the periphery of the filter element, may be advantageous in terms of discharging electrostatic charge. Due to the overall low percentage of carbon fibers, which are sufficient in order to discharge electrostatic charges in a plurality of known media, the material costs of the filter material according to the invention are also comparatively low.

The filter material according to the invention and a filter element provided with this filter material are described in greater detail below based on an embodiment according to the drawing. Shown in a schematic representation, not to scale, are:

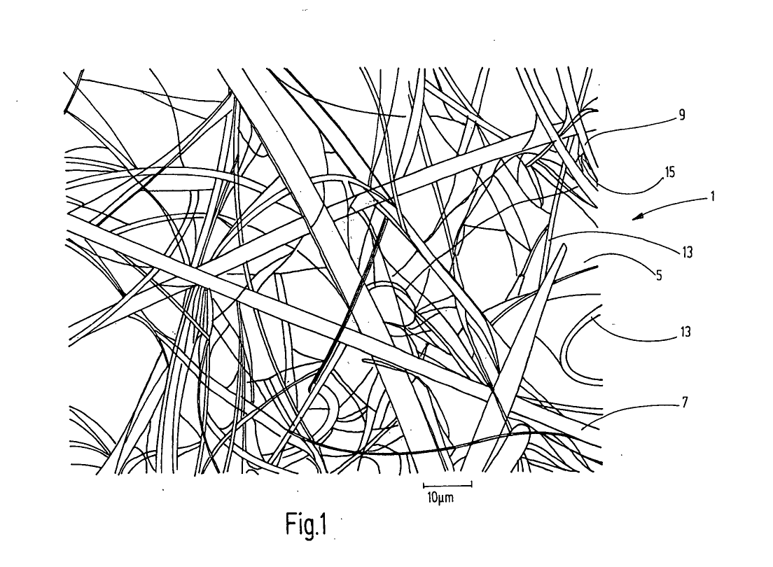

FIG. 1 a partial section of the filter material according to the invention in the form of a scanning electron microscope image;

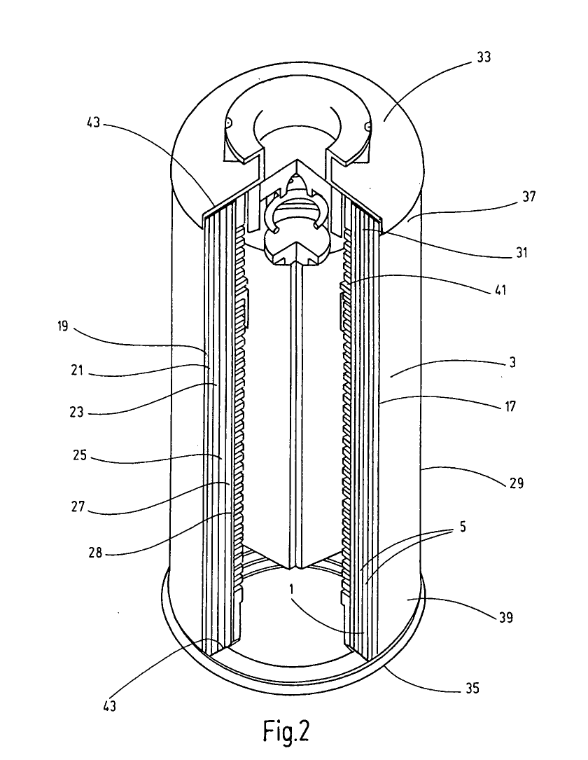

FIG. 2 a filter element having a filler material according to the invention in the form of a partially cut away perspective view.

FIG. 1 shows the structure of a filler material 1 in the form of a scanning electron microscope image, which material is used for a hydraulic filter 3, for example for a filter in a hydraulic system of a construction machine. An individual layer 5 of the filter material 1 is shown in the form of a spatial view based on the scanning electron microscope image. The individual layer 5 of the filler material 1 essentially comprises a composite of chaotically superimposed glass fibers 7 and carbon fibers 9. The glass fibers 7 and the carbon fibers 9 are disposed both in parallel planes to one another in relation to the longitudinal axis thereof and at an angular disposition to the image plane in FIG. 1. The percentage of carbon fibers 9 in the composite is therefore less than the percentage of glass fibers 7. The percentage of carbon fiber in the composite shown is approximately 10% of the percentage of glass fibers. The glass fibers 7 are formed out of a mineral glass, out of borosilicate glass. The composite also contains a percentage of thermal bonding fibers 13 made of plastic, in particular of polyethylene, polyamide and polypropylene. The thermal bonding fibers 13 are used in particular, as shown, as a connector between the glass fibers 7 and carbon fibers 9 in the filter material 1. For this purpose, the thermal bonding fibers 13 are disposed in such a way that they loop around or enclose the glass fibers 7 and the carbon fibers 9 at various locations and, extending across a depth range of the filter material 1, form connection points in each spatial direction of the filter material 1.

The connection of the thermal bonding fibers 13 to the glass fibers 7 and the carbon fibers 9 is improved in terms of the strength, especially the tensile strength thereof, by means of additives 15, such as liquid and fully polymerized acrylic resin, or epoxy resin, or even a suitable polymerizing elastomer, which are added to the chaotic matrix during or after production. The filter material 1 shown in FIG. 1 has a borosilicate fiber 7 content of approximately 80%, a synthetic thermal bonding fiber 13 content of approximately 5%, an additive 15 content of approximately 5%, and a carbon fiber 9 content of approximately 10%. Due to the orientation of the carbon fibers 9 in the filter material 1, both above on another in nearly parallel planes and in the connection of the planes, it is possible that preferably no charge separation occurs when a medium flows through the filter material 1, thus no electrostatic potentials occur. Insofar as the medium flowing to the filter material 1 already has potential differences, due to their spatial arrangement in the filter material 1, the carbon fibers 9 are able to form a continuous discharge route, in particular a plurality of discharge routes, for electrostatic charges. If the filter material 1 is used in a filter 3, which is shown merely as an example in FIG. 2, electrostatic charges of this kind are preferably discharged, by means of discharge elements, to a ground in the periphery of the filter 3.

In such a filter 3, the filter material 1 shown in FIG. 1 is preferably kept in planar contact with at least one additional functional layer 17 of the filter 3. The functional layer 17 may be a support grid 19 or a fleece material 21. Although the abovementioned additives 15 effect a significant improvement in the fiber anchoring of the composite of glass fibers 7 and carbon fibers 9, combined with a high degree of flexibility and mechanical stress resistance of the filter material, it is pertinent and advantageous to the improvement of the manageability of the filter material that a support grid and fleece materials of this kind be used in a composite in the form of a filter element 29 having a filter material 1.

The filter 3 shown in FIG. 2 is constructed in the form of a so-called filter element 29 and has a filter medium 31, which extends between two end caps 33, 35. The end caps 33, 35 are each connected to an assignable end region 37, 39 of the filter medium 31. The filter medium 31 is supported internally on a fluid-permeable support tube 41. In addition, the filter medium 31 is connected at the aforementioned end regions 37 and 39 to the end caps 33, 35 by means of an adhesive layer 43.

The medium passes from the outside to the inside for cleaning through the filter medium 31, wherein for the sake of simplifying the illustration, filter medium 31 is depicted in the form of a cylindrical filter matt component. The filter medium 31 may also be advantageously designed such that it is pleated and disposed around the support tube 41 in the form of filter folds. The filter medium 31 is designed having multiple layers, wherein the multi-layer structure in particular has an external support grid 19 and serves to stabilize the further layer structure. Comparable to this, an additional, inner support grid 28 may be present. A fleece material 21, 27 is attached to each respective support grid 19, 28. Thus the structure of the filter medium 31 is initially symmetrical when viewed via its depth. An individual layer 5 of a large-pore fiber material 23 made out of glass fibers 7 and carbon fibers 9 is attached to the fleece material 21. An additional individual layer 5 of a fine-pore fiber material 25 made out of glass fibers 7 and carbon fibers 9 is in contact with the individual layer of this kind. The two individual layers 23, 25 are essentially constructed as shown in FIG. 1 and in particular the carbon fibers 9 thereof are guided by means of discharge elements in the end caps 33, 35, not shown in greater detail, and are connected to at least one surface area of the outer surface of the filter element 29. In this way, electrostatic charges can be discharged from the filter element 29 to a part of the periphery of the filter element 29 forming a ground, such as, for example, a hydraulic system. The essential structure of such a filter element 29 is described in greater detail in a prior application by the applicant (DE 10 2008 004 344 A1), thus a description of additional components and functions of the filter element 29 depicted here shall be dispensed with.

1. A filter material, in particular for hydraulic filters (3), such as oil filters, comprising at least one individual layer (5) of a composite of glass fibers (7) with carbon fibers (9).

2. The filter material according to claim 1, characterized in that the percentage of carbon fibers (9) in the composite is lower than the percentage of glass fibers (7).

3. The filter material according to claim 1, characterized in that the percentage of carbon fibers (9) in the composite is approximately 5% to 30%, preferably approximately 10%.

4. The filter material according to claim 1, characterized in that the glass fibers (7) are formed out of borosilicate glass.

5. The filter material according to claim 1, characterized in that the glass fibers (7) and/or the carbon fibers (9) in the composite are chaotic or exist as a fabric.

6. The filter material according to claim 1, characterized in that the composite made of glass fibers (7) and carbon fibers (9) also contains thermal bonding fibers (13) made of plastic, such as polyethylene, polyamide or polypropylene.

7. The filter material according to claim 1, characterized in that the composite made of glass fibers (7) and carbon fibers (9) is at least partially formed by additives (15) such as binders, such as acrylic resin, epoxy resin or a polymerizing elastomer.

8. The filter material according to claim 1, characterized in that the filter material (1) is formed out of approximately 70% to 90%, preferably approximately 80% borosilicate fibers (7), 3% to 20%, preferably approximately 5% plastic thermal bonding fibers (13), 3% to 20%, preferably approximately 5% additives (15) and approximately 5% to 30%, preferably 10% carbon fibers (9).

9. The filter material according to claim 1, characterized in that the filter material (1) is in planar contact with at least one additional functional layer (17) of a filters (3).

10. The filter material according to claim 9, characterized in that the functional layer (17) is a support grid (19, 28).

11. A filter element, characterized in that said element contains a filter material (1) according to claim 1.

12. The filter element according to claim 11, characterized in that the filter element (29) comprises at least the following sequence of individual layers (5):
support grid (19)
fleece material (21)
large-pore fiber material (23)
fine-pore fiber material (25)
fleece material (27)
support grid (28).
